(19) United States
(12) Patent Application Publication
(10) Pub. No.: US 2019/0316949 A1
(43) Pub. Date: Oct. 17, 2019

(54) Tubular Dipstick Apparatus

(71) Applicants: Keegen Riley Mould, (US); Robert James Haskin, III, (US)

(72) Inventors: Keegen Riley Mould, Overland Park, KS (US); Robert James Haskin, III, Leawood, KS (US)

(21) Appl. No.: 15/954,248

(22) Filed: Apr. 16, 2018

(51) Int. Cl. G01F 23/04; G01F 23/02

(52) U.S. Cl. CPC G01F 23/04; G01F 23/02

(57) ABSTRACT

The invention is a dipstick apparatus generally consisting of a transparent tube, a handle, and a user-manipulated connector line with a lower stopper. Furthermore, above the handle, the line is shaped to limit displacement, maintain functionality, and improve ergonomics. The invention collects vehicular fluids via insertion into reservoirs or dipstick tubes, then a push and a pull upon the connector line. This action lowers and raises the stopper, allowing the fluid to equilibrate before entrapping it within the flexible tube of the invention. The dipstick is then extracted, and the user is able to determine the fluid level by measuring it against predetermined markings found on the flexible tube. In preferred embodiments, the device utilizes a transparent tube that is heat-resistant as well as flexible, in order to be as universally applicable as possible. Accordingly, the connector line is flexible and heat-resistant, and may be permanently connected to the stopper.

### CROSS-REFERENCE TO RELATED APPLICATIONS

This application is a continuation of and claims priority to U.S. patent application Ser. No. 62/603,969 filed on Jun. 19, 2017. U.S. patent application Ser. No. 62/603,969 is hereby incorporated by reference.

### STATEMENT REGARDING FEDERALLY-SPONSORED RESEARCH

N/A

### REFERENCE TO SEQUENCE LISTING, A TABLE, OR A COMPUTER PROGRAM LISTING COMPACT DISC APPENDIX

N/A

### BACKGROUND OF THE INVENTION

### 1. Field of the Invention

This invention relates to the field of monitoring devices and more particularly pertains to a new monitoring device for vehicular fluid reservoirs.

### 2. Description of Prior Art

Fluid levels are difficult to determine for many people, and the pinnacle of current dipstick design leaves something to be desired. Newly replaced oil can be difficult to see and accurately read on a dipstick due to its transparency. In some instances, the dipstick will become discolored and appear similar in color to the oil itself, increasing confusion during measurement. Electronic solutions to this problem inherently add possibilities for failure and distrust due to a degree of separation from the user and their numerous parts, in addition to increased monetary cost to the user.

### SUMMARY OF INVENTION

The following is intended to be a brief summary of the invention and is not intended to limit the scope of the invention.

The invention is wholly unique in that it utilizes a stopper at the bottom of a transparent, flexible, heat resistant tube in order to trap oil in the tube and clearly display it to the user. The dipstick is inserted into the dipstick tube in the regular fashion. A line from the top of the handle through the dipstick is used as a method to allow the user to manipulate the stopper as needed. The stopper is first pushed by the connecting line, unmating it from the tube, and then pulled back up by the same line, rejoining the stopper with the tube, and forming a seal. The user then removes the dipstick from the dipstick tube and reads the fluid level. This method of level determination is more reliable and easier to read than the traditional one. The user has a direct connection to the measurement, and can also manually troubleshoot, regardless of expertise.

### BRIEF DESCRIPTION OF THE DRAWINGS

The disclosure will be better understood and objects other than those set forth above will become apparent when consideration is given to the following detailed descriptions thereof. Such descriptions make reference to the annexed drawings wherein:

FIG. 1 is a front view of an oil level monitoring system according to an embodiment of the disclosure.

FIG. 2 is a side view of an embodiment of the disclosure.

FIG. 2A is a section view taken along line 1-1 of FIG. 2 of an embodiment of the disclosure.

FIG. 2B is a detail view taken from circle B of FIG. 2A of an embodiment of the disclosure.

FIG. 3 is a top view of an embodiment of the disclosure.

FIG. 4 is an isometric view of an embodiment of the disclosure.

FIG. 5 is a front view of an embodiment of the disclosure FIG. 5A is a section view taken along line 1-1 of FIG. 5 of an embodiment of the disclosure.

FIG. 6 is a top view of an embodiment of the disclosure.

FIG. 7 is an isometric view of an embodiment of the disclosure.

FIG. 8 is a front view of an embodiment of the disclosure.

FIG. 8A is a section view taken along line 1-1 of FIG. 8 of an embodiment of the disclosure.

FIG. 9 is a section view taken down the middle from face to face of the same object represented in FIG. 10.

FIG. 9A is a section view taken along line 1-1 of FIG. 9 of an embodiment of the disclosure.

FIG. 10 is an isometric view of an embodiment of the disclosure.

FIG. 11 is a front view of an embodiment of the disclosure.

FIG. 11A is a detail view taken from circle A of FIG. 11 of an embodiment of the disclosure.

FIG. 11B is a section view taken along line 1-1 from detail view 11A of an embodiment of the disclosure.

FIG. 12 is a front view of an embodiment of the disclosure.

FIG. 12A is a section view taken along line 1-1 of FIG. 12 of an embodiment of the disclosure.

### DETAILED DESCRIPTION OF THE PREFERRED EMBODIMENT

The terminology used herein is for the purpose of describing particular embodiments only and is not intended to be limiting of the invention. As used herein, the term “and/or” includes any and all combinations of one or more of the associated listed items. The singular forms “a,” “an,” and “the,” as used herein, are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention and is not intended to limit the invention to the specific embodiments illustrated by the figure(s) or description below. New dipstick devices, apparatuses, and methods for fluid level determination are discussed herein. In the following description, for purposes of explanation, numerous specific details are set forth in order to provide a thorough understanding of the present invention. It will be evident, however, to one skilled in the art, that the present invention may be practiced without these specific details.

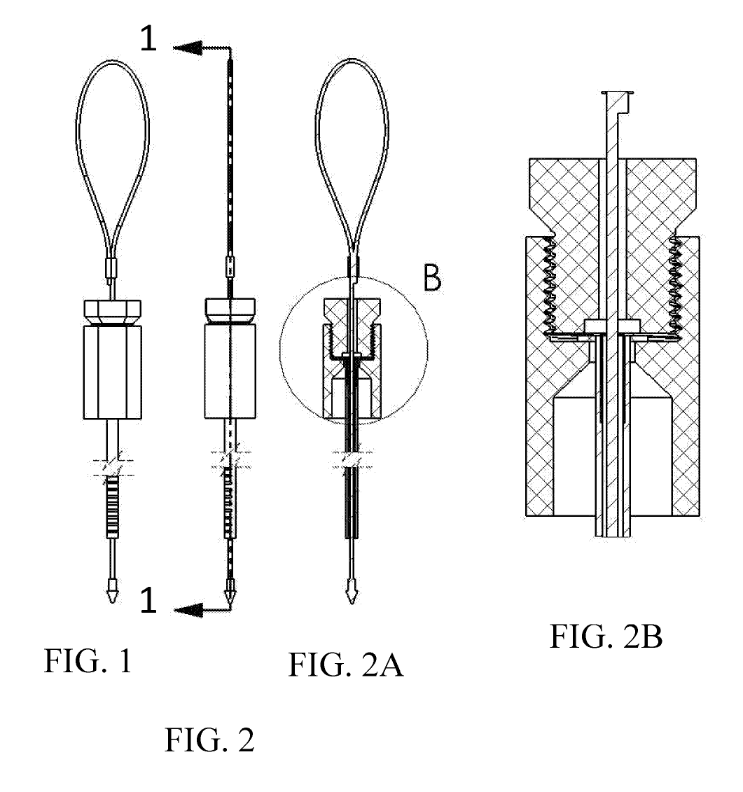

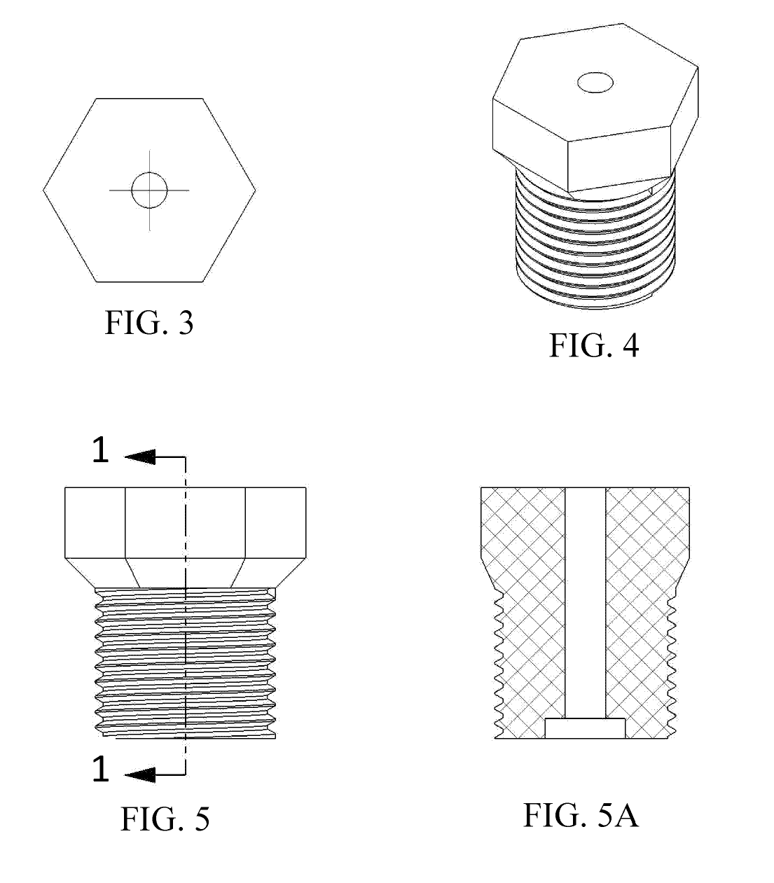

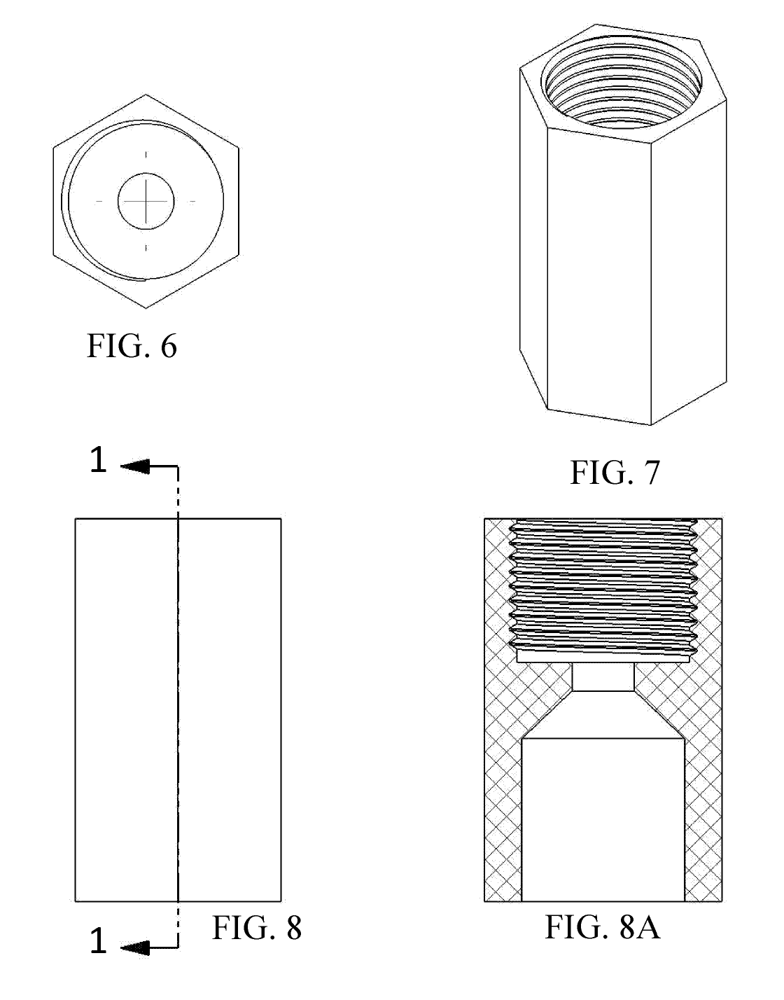

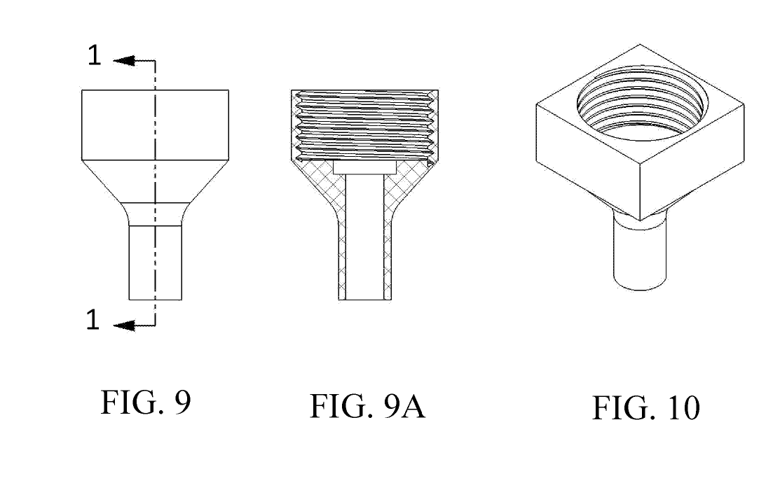

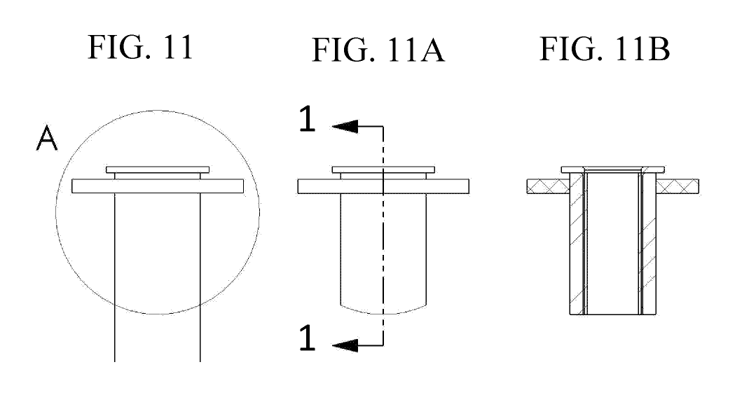

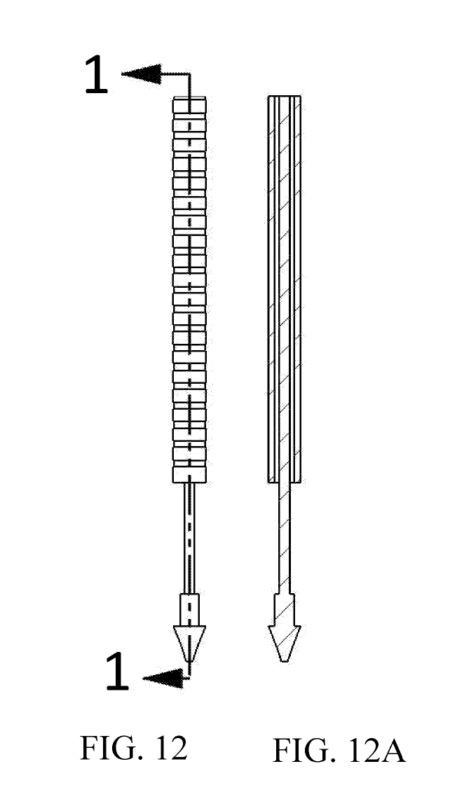

The present invention will now be described by referencing the appended figures representing preferred embodiments. The invention is best implemented to measure the amount of oil in an engine and consists of multiple parts. The optimal embodiment includes a plastic handle, as represented by FIGS. 3-5A, nylon or other heat resistant plastic attachments that mate with the handle, as represented by FIGS. 6-10, a silicone tube as can be seen in FIGS. 1, 12, a tube support and washer for securing the silicone tube, as represented in FIGS. 11-11B, and a road-bicycle brake cable used as the line and attached stopper, which is represented in FIGS. 1-2A, 12A. The cable has a permanent stopper at one end, as represented by FIGS. 12, 12A, and so must be inserted through the bottom of the tube and up through the handle. Above the handle, the cable may be looped and fed into a crimp, as seen in FIGS. 1-2A, to allow the user to easily push or pull the cable. The crimp may be placed to the user's liking and allows for an inverse relationship between loop size and range of motion. Additionally, for increased precision, markings may be drawn or engraved onto the tube as a system for discerning the actual and ideal operating oil levels inside a vehicle; this is shown in FIGS. 1, 12. The main parts depicted in FIG. 1 of the invention are a transparent, heat-resistant, and flexible tube; a handle; the “outer” version of the attachment that mates with the handle, a flexible, heat-resistant line with a stopper, a tube support, a washer, and a cable crimp that is used to form a shape not small enough to pass through the handle and tube. These parts work in tandem to allow precise and accurate fluid level readings in dipstick tubes at any operable temperature and inside nearly any dipstick tube.

Injection molding and/or 3D printing would be the preferred method of manufacture of the handle of the dipstick design. Injection molding or extrusion, or utilization of a pre-made cable, cable with attached stopper, metal line, or plastic line are both preferred methods of manufacture of the line and stopper.

Although this invention has been described in specific detail with reference to the disclosed embodiments, it will be understood that many variations and modifications may be effected within the spirit and scope of the invention.

What is claimed is:

1. A tubular dipstick apparatus for collecting and measuring vehicular fluid levels via a transparent tube with a stopper at the bottom used to seal the tube, comprising:
a handle assembly with one or more corresponding attachments;
a transparent, flexible, heat-resistant tube;
a system of fasteners to secure the tubing to the handle assembly;
a flexible, heat-resistant line used to transfer force from the user to the stopper;
a heat-resistant stopper connected to the line; and
a means of connecting the line to itself above the handle.

2. A tubular dipstick apparatus of claim 1 further comprising of materials that are partially heat resistant or not heat resistant.

3. A tubular dipstick apparatus of claim 1 further utilizing lines of measurement located on the transparent tube.
